(19) United States
(12) Patent Application Publication
(10) Pub. No.: US 2022/0161489 A1
(43) Pub. Date: May 26, 2022

(54) PRINTING DEVICE, AND METHOD AND DEVICE FOR PRODUCING PRINTED MATTER

(71) Applicant: Yuuki MATSUSHITA, Kanagawa (JP)

(72) Inventor: Yuuki MATSUSHITA, Kanagawa (JP)

(73) Assignee: Ricoh Company, Ltd., Tokyo (JP)

(21) Appl. No.: 17/454,064

(22) Filed: Nov. 9, 2021

(30) Foreign Application Priority Data
Nov. 26, 2020 (JP) 2020-195770
Oct. 1, 2021 (JP) 2021-162659

(51) Int. Cl. B29C 64/209; C09D 11/033; C09D 11/037; C09D 11/107; B33Y 10/00; B33Y 30/00; B33Y 70/10

(52) U.S. Cl. CPC B29C 64/209; C09D 11/033; C09D 11/037; B29K 2033/12; B33Y 10/00; B33Y 30/00; B33Y 70/10; C09D 11/107

(57) ABSTRACT

A printing device includes an ink, an ink heating unit, and an ink discharging unit. The ink includes water, a metal pigment, and a resin. A mass ratio of the resin to the metal pigment is 0.1 or greater but 2 or less. A proportion of the water in the ink is 1% by mass or greater but 30% by mass or less. The ink heating unit is configured to heat the ink. The ink discharging unit is configured to discharge the ink heated.

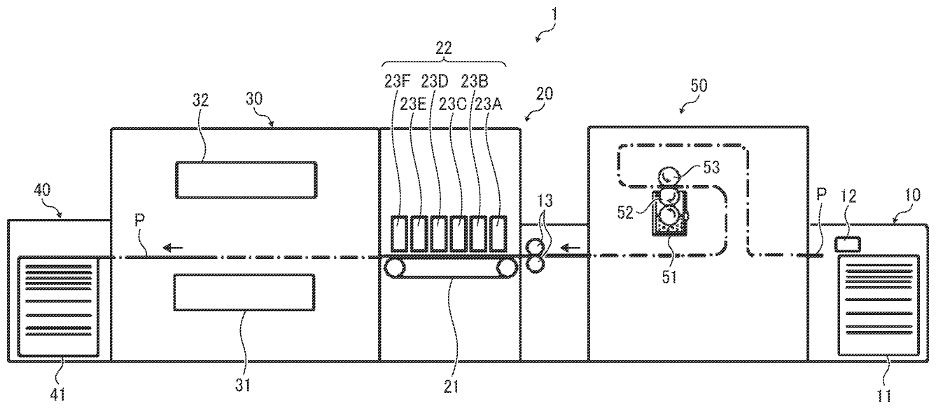

### CROSS-REFERENCE TO RELATED APPLICATIONS

This patent application is based on and claims priority pursuant to 35 U.S.C. § 119(a) to Japanese Patent Application No. 2020-195770, filed on Nov. 26, 2020 and Japanese Patent Application No. 2021-162659, filed on Oct. 1, 2021, in the Japan Patent Office, the entire disclosure of each of which is hereby incorporated by reference herein.

### BACKGROUND

### Technical Field

The present disclosure relates to a printing device, and a method and a device for producing printed matter.

### Description of the Related Art

An inkjet printing system is a printing system where ink droplets are directly discharged from very fine nozzles towards a print member to deposit the ink on the print member to obtain letters or an image. The inkjet printing system has not only advantages that a device for use releases only small noise and has excellent usability, but also advantages that color image formation is easily achieved and plain paper can be used as a print member. Accordingly, the inkjet printing system is widely used as output devices for office or home use.

In the industrial use of the inkjet printing system, moreover, application as an output device of digital printing has been expected owing to improvement in the inkjet technology. Printers capable of printing on a nonabsorbable base with a solvent ink or UV ink have been actually available on the market.

In addition, the inkjet technology has been applied for decorative printing giving metallic gloss, as well as printing of letters and images, by introducing a metallic ink using a metal pigment.

### SUMMARY

According to one aspect of the present disclosure, a printing device includes an ink, an ink heating unit, and an ink discharging unit. The ink includes water, a metal pigment, and a resin. A mass ratio of the resin to the metal pigment is 0.1 or greater but 2 or less. A proportion of the water in the ink is 1% by mass or greater but 30% by mass or less. The ink heating unit is configured to heat the ink. The ink discharging unit is configured to discharge the ink heated.

### BRIEF DESCRIPTION OF THE DRAWING

A more complete appreciation of the disclosure and many of the attendant advantages and features thereof can be readily obtained and understood from the following detailed description with reference to the accompanying drawing, wherein the drawing is a schematic view illustrating an example of the printing device of the present disclosure.

The accompanying drawing is intended to depict embodiments of the present invention and should not be interpreted to limit the scope thereof. The accompanying drawing is not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

The present disclosure can provide a printing device achieving excellent discharging stability of an ink, capable of forming an image having excellent abrasion resistance and image gloss, and capable of preventing formation of image defects.

### (Printing Device and Printing Method)

The printing device of the present disclosure includes an ink, an ink heating unit, and an ink discharging unit, and may further include an ink storing unit and other units according to the necessity. The ink includes water, a metal pigment, and a resin. A mass ratio of the resin to the metal pigment is 0.1 or greater but 2 or less. A proportion of the water in the ink is 1% by mass or greater but 30% by mass or less. The ink heating unit is configured to heat the ink. The ink discharging unit is configured to discharge the ink heated.

A printing method associated with the printing device of the present disclosure includes an ink heating step and an ink discharging step, and may further include other steps according to the necessity. The ink heating step is a step of heating an ink. The ink discharging step is a step of discharging the ink heated. The ink includes water, a metal pigment, and a resin. A mass ratio of the resin to the metal pigment is 0.1 or greater but 2 or less. A proportion of the water in the ink is 1% by mass or greater but 30% by mass or less.

Related art proposes a method for improving abrasion resistance including adding a resin to an ink to enhance the strength of a coating film formed with the ink. As an amount of the resin in the ink increases, however, the viscosity of the ink increases. As a result, the number of discharge failures of the ink caused or the number of satellite droplets formed increases, and image defects (mist image) due to generation of the ink mist may be caused.

Related art does not consider such problems that discharging stability of an ink is impaired, jet ink droplets (ligament length) in the air just after discharging become long, and image defects occur due to formation of satellite droplets, when an amount of a resin in the ink is increased to improve durability of an image to be formed. Nor does the related art consider such problems that viscosity of an ink for use is low and image defects occur.

After the studies diligently conducted by the inventor of the present invention, the inventor has found that, even when the amount of a resin in an ink is large, discharging stability of the ink is excellent, abrasion resistance and image gloss of an image to be formed are excellent, and occurrences of image defects can be suppressed by using an ink and an ink heating unit configured to heat the ink, the ink including water, a metal pigment, and a resin, where a mass ratio of the resin to the metal pigment is 0.1 or greater but 2 or less, and a proportion of the water in the ink is 1% by mass or greater but 30% by mass or less.

### [Ink]

The ink includes water, a metal pigment, and a resin. Amass ratio (resin/metal pigment) of the resin to the metal pigment is 0.1 or greater but 2 or less. The ink may further include an organic solvent and other components according to the necessity.

When the mass ratio (resin/metal pigment) of the resin to the metal pigment is 0.1 or greater but 2 or less in the ink of the present disclosure, discharging stability of the ink is excellent, abrasion resistance and image gloss of a coating film formed with the ink are improved, and occurrences of image defects can be suppressed. The mass ratio (resin/metal pigment) of the resin to the metal pigment is preferably 0.4 or greater but 1.5 or less.

Moreover, the ink of the present disclosure has a viscosity of 15 mPa·s or greater at 25° C. When such an ink is used for a discharging system, such as an inkjet system, discharging failures may be caused, or image defects may occur due to increased satellite droplets. In the present disclosure, the viscosity of the ink at the time of discharging can be reduced by heating the ink just before discharging using the ink heating unit configured to heat the ink before discharging. As a result, the ink having the increased viscosity due to the increased amount of the resin can be discharged w % bile reducing the viscosity thereof. Therefore, when used in an inkjet system, the ink can form an image having excellent abrasion resistance and image gloss while preventing such problems that discharge failures may be caused, the jetted ink droplets (ligament length) in the air just after discharging become long, and the number of satellite droplets is increased to cause image defects.

### —Metal Pigment—

The metal pigment is not particularly limited and may be appropriately selected depending on the intended purpose. Examples of the metal pigment include, but are not limited to: simple metals, such as aluminium, silver, gold, platinum, nickel, chromium, zinc, and copper; and metal oxides, such as titanium dioxide, zinc oxide, silica, alumina, magnesium oxide, zirconium dioxide, indium oxide, and tin oxide.

The above-listed examples may be used alone or in combination.

The shape of the metal pigment is not particularly limited and may be appropriately selected depending on the intended purpose. Examples thereof include, but are not limited to, flakes, true spheres, and amorphous shapes.

When the metal pigment is in the shape of flakes, the 50% volume average particle diameter R₅₀ of circle equivalent diameters determined from the areas in a plane view is 0.4 μm or greater but 3 μm or less and more preferably 0.5 μm or greater but 2.5 μm or less.

When the metal pigment is in the shape of particles, the volume average particle diameter of the particles is preferably 0.05 μm or greater but 0.4 μm or less and more preferably 0.1 μm or greater but 0.35 μm or less.

When the size of the metal pigment is within the above-mentioned ranges, metal gloss of natural silver can be obtained.

The particle diameter of the metal pigment can be measured by means of a particle size analyzer (Nanotrac Wave-UT151, obtained from MicrotracBEL Corp.).

Examples of a method for dispersing the metal pigment include, but are not limited to, a method where a hydrophilic functional group is introduced to the metal pigment to prepare a self-dispersible pigment, a method where a surface of the pigment is coated with a resin for dispersing, and a method where the pigment is dispersed using a dispersant.

Examples of the method for introducing a hydrophilic functional group to the metal pigment to prepare a self-dispersible pigment include, but are not limited to, a method where a functional group, such as a sulfone group and a carboxyl group, is added to the pigment to make the pigment dispersible.

Examples of the method where a surface of the metal pigment is coated with a resin for dispersing include, but are not limited to, a method where the metal pigment is encapsulated in microcapsules to make the metal pigment dispersible. Such a metal pigment is referred to as a resin-coated pigment. In this case, the pigment blended to the ink is not necessarily entirely coated with a resin. A metal pigment that is not coated with a resin or a metal pigment partially coated with a resin may be also dispersed in an ink as long as an effect obtainable by the present disclosure is not adversely affected.

Examples of the method where the metal pigment is dispersed using a dispersant include, but are not limited to, a method where the pigment is dispersed using a known low-molecular-weight (weight average molecular weight: lower than 10,000) dispersant, or high-molecular-weight (weight average molecular weight: 10,000 or higher) dispersant, such as a surfactant.

The dispersant for use depends on the metal pigment for use. For example, an anionic surfactant, a cationic surfactant, an amphoteric surfactant, or a nonionic surfactant can be used as the dispersant.

Examples of the anionic surfactant include, but are not limited to, sodium naphthalene sulfonate formaldehyde condensate.

Examples of the cationic surfactant include, but are not limited to, dimethylaminopropyl stearamide.

Examples of the amphoteric surfactant include, but are not limited to, alkyl polyaminoethyl glycine.

Examples of the nonionic surfactant include, but are not limited to, RT-100 obtained from TAKEMOTO OIL&FAT CO., LTD.

The above-listed examples may be used alone or in combination.

Considering improved image density, excellent fixability, and discharging stability of the ink, a proportion of the metal pigment in the ink is preferably 0.1% by mass or greater but 13% by mass or less and more preferably 5% by mass or greater but 11% by mass or less.

### [Qualitative Method of Metal Pigment]

There are several qualitative methods of the metal pigment in the ink. Examples of the qualitative method of the metal pigment include, but are not limited to, an analysis method according to energy dispersive X-ray spectroscopy (SEM-EDX).

As the qualitative method of the metal pigment in the ink, more specifically, an electron beam is emitted to the ink by SEM, the released X-ray is detected by EDX, and elements constituting the metal pigment can be detected based on the X-ray spectrum detected by EDX.

### —Resin—

The resin functions as a fixing resin in a coating film formed with the ink, and can improve fixability and abrasion resistance of the coating film.

The resin is not particularly limited and may be appropriately selected depending on the intended purpose. Examples of the resin include, but are not limited to, urethane resins, polyester resins, acrylic resins, methacrylic resins, vinyl acetate resins, styrene resins, butadiene resins, styrene-butadiene resins, vinyl chloride resins, acrylic styrene resins, acryl silicone resins, and copolymers thereof. The above-listed examples may be used alone or in combination.

The resin particles may be appropriately synthesized for use, or may be selected from commercially available products.

Examples of the commercially available products include, but are not limited to, FS-101, obtained from NIPPON PAINT INDUSTRIAL COATINGS CO., LTD.

The shape of the resin is not particularly limited and may be appropriately selected depending on the intended purpose. Examples thereof include, but are not limited to, particle shapes, such as spherical particles and amorphous particles. Moreover, the resin may be in the form of a resin emulsion where the resin is dispersed in a solvent.

When the resin is in the shape of particles, the volume average particle of the resin particles is preferably 10 nm or greater but 1,000 nm or less, more preferably 10 nm or greater but 200 nm or less, and particularly preferably 10 nm or greater but 100 nm or less. When the volume average particle diameter of the resin particles is 10 nm or greater but 1,000 nm or less, fixability of a coating film is improved to achieve sufficient hardness of an image. For example, the volume average particle diameter can be measured by means of a particle size analyzer (Nanotrac Wave-UT151, obtained from MicrotracBEL Corp.).

The proportion of the resin in the ink is preferably 0.50% by mass or greater but 10% by mass or less, more preferably 2.0% by mass or greater but 10.0% by mass or less, and particularly preferably 4.0% by mass or greater but 10.0% by mass or less. When the proportion of the resin in the ink is 0.50% by mass or greater but 10.0% by mass or less, abrasion resistance can be improved, formation of satellites is suppressed, and mist generated due to the satellites is reduced to suppress occurrences of image defects.

### [Quantitative Method of Resin]

Examples of the quantitative method of the rein in the ink include, but are not limited to, a method for observing a reduction in mass as heated, by means of a thermogravimetry-differential thermal analyzer (TG-DTA). After evaporating water and solvent components in advance to measure the reduced amount, the reduction in mass caused by heating the solids is measured again, to thereby determine an amount of the resin included in the ink.

Other examples thereof include, but are not limited to, a method where the resin component is separated, and a mass of the separated resin component is measured.

### —Water—

The water is not particularly limited and may be appropriately selected depending on the intended purpose. Examples of the water include, but are not limited to, pure water, such as ion-exchanged water, ultrafiltered water, reverse osmosis water, and distilled water, and ultrapure water.

The proportion of the water in the ink is 1% by mass or greater but 30% by mass or less, preferably 1% by mass or greater but 20% by mass or less, and more preferably 1% by mass or greater but 10% by mass or less. When the proportion of the water in the ink is 1% by mass or greater but 30% by mass or less, discharging stability of the ink can be improved.

### —Organic Solvent—

When the solvent of the ink used for the printing device of the present disclosure is an organic solvent, drying properties near a nozzle from which the ink is discharged are excellent compared to the case of the ink using water as the solvent. Therefore, the discharging stability of the ink can be improved.

There is no specific limitation on the type of the organic solvent used in the present disclosure. For example, water-soluble organic solvents are suitable.

Specific examples thereof include, but are not limited to, polyol-based solvents, ether-based solvents such as polyol alkylethers and polyol arylethers, nitrogen-containing heterocyclic compound-based solvents, amide-based solvents, amine-based solvents, and sulfur-containing compound-based solvents.

Specific examples of the water-soluble organic solvents include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether: polyol arylethers such as ethylene glycol monophenylether and ethylene glycol monobenzylether; nitrogen-containing heterocyclic compounds such as 2-pyrolidone, N-methyl-2-pyrolidone, N-hydroxyethyl-2-pyrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propioneamide, and 3-butoxy-N,N-dimethyl propioneamide; amines such as monoethanolamine, diethanolamine, and triethylamine: sulfur-containing compounds such as dimethyl sulfoxide, sulfolane, and thiodiethanol: propylene carbonate, and ethylene carbonate.

Since the water-soluble organic solvent serves as a humectant and also imparts a good drying property, it is preferable to use an organic solvent having a boiling point of 250 degrees C. or lower.

The proportion of the organic solvent in the ink is preferably 10% by mass or greater but 75% by mass or less and more preferably 30% by mass or greater but 60% by mass or less.

### [Qualitative Analysis Method and Quantitative Analysis Method of Organic Solvent]

There are several qualitative and quantitative methods of the organic solvent in the ink and the head cleaning web. Examples thereof include, but are not limited to, a method according to gas chromatography-mass spectrometry (GC-MS). Moreover, quantitative analysis can be performed by creating s calibration curve.

### —Additive—

The ink may further optionally contain a surfactant, a defoaming agent, a preservative and fungicide, a corrosion inhibitor, a pH regulator, etc.

### —Surfactant—

As the surfactant, a silicone-based surfactant, a fluorosurfactant, an amphoteric surfactant, a nonionic surfactant, or an anionic surfactant may be used.

The silicone-based surfactant has no specific limit and can be suitably selected to suit to a particular application. Of these, preferred are silicone-based surfactants which are not decomposed even in a high pH environment. Specific examples thereof include, but are not limited to, side-chain-modified polydimethylsiloxane, both end-modified polydimethylsiloxane, one-end-modified polydimethylsiloxane, and side-chain-both-end-modified polydimethylsiloxane. A silicone-based surfactant having a polyoxyethylene group or a polyoxyethylene polyoxypropylene group is particularly preferable because such an agent demonstrates good characteristics as an aqueous surfactant. It is possible to use a polyether-modified silicone-based surfactant as the silicone-based surfactant. A specific example thereof is a compound in which a polyalkylene oxide structure is introduced into the side chain of the Si site of dimethyl siloxane.

Specific examples of the fluoro surfactants include, but are not limited to, perfluoroalkyl sulfonic acid compounds, perfluoroalkyl carboxylic acid compounds, perfluoroalkyl phosphoric acid ester compounds, adducts of perfluoroalkyl ethylene oxide, and polyoxyalkylene ether polymer compounds having a perfluoroalkyl ether group in its side chain. These are particularly preferable because they do not foam easily. Specific examples of the perfluoroalkyl sulfonic acid compounds include, but are not limited to, perfluoroalkyl sulfonic acid and salts of perfluoroalkyl sulfonic acid. Specific examples of the perfluoroalkyl carboxylic acid compounds include, but are not limited to, perfluoroalkyl carboxylic acid and salts of perfluoroalkyl carboxylic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain and salts of polyoxyalkylene ether polymers having a perfluoroalkyl ether group in its side chain. Counter ions of salts in these fluorine-based surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides, etc.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The silicone-based surfactants has no particular limit. Specific examples thereof include, but are not limited to, side-chain-modified polydimethyl siloxane, both end-modified polydimethylsiloxane, one-end-modified polydimethylsiloxane, and side-chain-both-end-modified polydimethylsiloxane. In particular, a polyether-modified silicone-based surfactant having a polyoxyethylene group or a polyoxyethylene polyoxypropylene group is particularly preferable because such a surfactant demonstrates good characteristics as an aqueous surfactant.

Any suitably synthesized surfactant and any product thereof available on the market is suitable. Products available on the market are obtained from Byc Chemie Japan Co., Ltd., Shin-Etsu Silicone Co., Ltd., Dow Corning Toray Co., Ltd., etc., NIHON EMULSION Co., Ltd., Kyoeisha Chemical Co., Ltd., etc.

The polyether-modified silicon-containing surfactant has no particular limit. For example, a compound in which the polyalkylene oxide structure represented by the following Chemical structure S-1 is introduced into the side chain of the Si site of dimethyl polysiloxane.

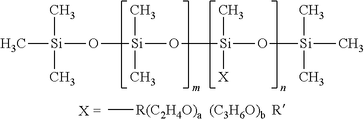

Chemical structure S-1

In the Chemical structure S-1, “m”, “n”, “a”, and “b” each, respectively represent integers, R represents an alkylene group, and R′ represents an alkyl group.

Specific examples of polyether-modified silicone-based surfactants include, but are not limited to, KF-618, KF-642, and KF-643 (all manufactured by Shin-Etsu Chemical Co., Ltd.). EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Co., Ltd.), BYK-33 and BYK-387 (both manufactured by BYK Japan KK.), and TSF4440, TSF4452, and TSF4453 (all manufactured by Momentive Performance Materials Inc.).

A fluorosurfactant in which the number of carbon atoms replaced with fluorine atoms is from 2 to 16 is preferable and, 4 to 16, more preferable.

Specific examples of the fluorosurfactants include, but are not limited to, perfluoroalkyl phosphoric acid ester compounds, adducts of perfluoroalkyl ethylene oxide, and polyoxyalkylene ether polymer compounds having a perfluoroalkyl ether group in its side chain. Of these, polyoxyalkylene ether polymer compounds having a perfluoroalkyl ether group in its side chain are preferable because they do not foam easily and the fluorosurfactant represented by the following Chemical formula F-1 or Chemical formula F-2 is more preferable.

CF₃CF₂(CF₂CF₂)ₘ—CH₂CH₂O(CH₂CH₂O)ₙ H Chemical formula F-1

In the Chemical formula F-1. “m” is preferably 0 or an integer of from 1 to 10 and “n” is preferably 0 or an integer of from 1 to 40.

CₙF₂ₙ₊₁—CH₂CH(OH)CH₂—O—(CH₂CH₂O)ₐ—Y Chemical formula F-2

In the Chemical formula F-2, Y represents H, CmF₂ₘ₊₁, where “m” is an integer of from 1 to 6, CH₂CH(OH)CH₂—CmF₂ₘ₊₁, where m represents an integer of from 4 to 6, or CₚH₂ₚ₊₁, where p represents an integer of from 1 to 19. “n” represents an integer of from 1 to 6. “a” represents an integer of from 4 to 14.

Products available on the market may be used as the fluorosurfactant. Specific examples of the products available on the market include, but are not limited to, SURFLON S-111, SURFLON S-112, SURFLON S-113, SURFLON S-121, SURFLON S-131, SURFLON S-132, SURFLON S-141, and SURFLON S-145 (all manufactured by ASAHI GLASS CO., LTD.): FLUORAD FC-93, FC-95, FC-98, FC-129, FC-135, FC-170C, FC-430, and FC-431 (all manufactured by SUMITOMO 3M); MEGAFACE F-470, F-1405, and F-474 (all manufactured by DIC CORPORATION): ZONYL™ TBS, FSP, FSA, FSN-100, FSN, FSO-100, FSO, FS-300, UR, CAPSTONE9® FS-30, FS-31, FS-3100, FS-34, FS-35 (all manufactured by The Chemours Company); FT-110, FT-250, FT-251, FT-400S. FT-150, and FT-400SW (all manufactured by NEOS COMPANY LIMITED), POLYFOX PF-136A, PF-156A, PF-151N, PF-154, PF-159 (all manufactured by OMNOVA SOLUTIONS INC.), and UNIDYNE DSN-403N (manufactured by DAIKIN INDUSTRIES). Of these, FS-3100, FS-34, and FS-300 (all manufactured by The Chemours Company), FT-110, FT-250, FT-251, FT-400S. FT-150, and FT-400SW (all manufactured by NEOS COMPANY LIMITED), PolyFox PF-151N (manufactured by OMNOVA SOLUTIONS INC.), and UNIDYNE DSN-403N (manufactured by DAIKIN INDUSTRIES) are particularly preferable in terms of good printing quality, coloring in particular, and improvement on permeation, wettability, and uniform dying property to paper.

The proportion of the surfactant in the ink is not particularly limited and may be appropriately selected depending on the intended purpose. It is preferably from 0.001 to 5 percent by mass and more preferably from 0.05 to 5 percent by mass ink in terms of excellent wettability and discharging stability and improvement on image quality.

### —Defoaming Agent—

The defoaming agent has no particular limit. For example, silicon-based defoaming agents, polyether-based defoaming agents, and aliphatic acid ester-based defoaming agents are suitable. These can be used alone or in combination. Of these, silicone-based foaming agents are preferable to easily break foams.

### —Preservatives and Fungicides—

The preservatives and fungicides are not particularly limited. An example thereof is 1,2-benzisothiazoline-3-on.

### —Corrosion Inhibitor—

The corrosion inhibitor has not particular limit. Examples thereof are acid sulfite and sodium thiosulfate.

### —pH Regulator—

The pH regulator has no particular limit. It is preferable to adjust the pH to 7 or higher. Examples thereof include, but are not limited to amines, such as diethanol amine and triethanol amine.

The physical properties of the ink are not particularly limited and may be appropriately selected depending on the intended purpose. For example, viscosity, surface tension, pH, etc., are preferably in the following ranges.

Considering improvement on printed matter density and text quality, and excellent dischargeability, the viscosity of the ink at 25° C. is preferably 1.0 mPa s or greater but 30 mPa·s or less and more preferably 2.0 mPa·s or greater but 25 mPa s or less. Moreover, the viscosity of the ink at 35° C. is preferably 15 mPa·s or less, more preferably 4.0 mPa s or greater but 15 mPa s or less, and even more preferably 5.0 mPa s or greater but 10 mPa·s or less.

The viscosity can be measured by, for example, a rotatory viscometer (RE-80L, manufactured by TOKI SANGYO CO., LTD.). As the measuring conditions, the measurement can be performed at 25° C. or 35° C. by Standard cone rotor (1°34′×R24), with the sample liquid amount of 1.2 mL, at the rotational speed of 50 rpm, for 3 minutes.

Moreover, the viscosity of the ink at the time of the discharging thereof is preferably controlled by the heating unit to 5.0 mPa s or greater but 15 mPa s or less, preferably 5.0 mPa s or greater but 10 mPa s or less.

The surface tension of the ink is preferably 35 mN/m or less and more preferably 32 mN/m or less at 25 degrees C. in terms that the ink is suitably levelized on a print medium and the drying time of the ink is shortened.

The pH of the ink is preferably 7 or higher but 12 or lower and more preferably 8 or higher but 11 or lower in terms of prevention of corrosion of metal materials contacting the ink.

The particle diameter of the solid portion in ink has no particular limit and may be appropriately selected depending on the intended purpose. For example, the maximum frequency in the maximum number conversion is preferably 20 nm or greater but 1,000 nm or less, and more preferably 20 nm or greater but 150 nm or less to ameliorate the discharging stability and image quality such as image density. The solid portion includes resin particles, particles of pigments, etc.

The particle diameter of the solid portion can be measured by using a particle size analyzer (Nanotrac Wave-UT151, manufactured by MicrotracBEL Corp).

### <Ink Heating Unit and Ink Heating Step>

The ink heating unit is a unit configured to heat the ink.

The ink heating step is a step of heating the ink.

The ink heating step can be suitably performed by the ink heating unit.

The ink heating unit is a unit configured to heat the ink before discharging the ink. Even when the amount of the resin in the ink is increased to improve abrasion resistance and the viscosity of the ink at 25° C. is 15 mPa s or greater, the viscosity of the ink can be sufficiently reduced at the time of the ink discharge by heating the ink before discharging the ink. Accordingly, it is possible to prevent such problems that discharging failures may occur, ink droplets (ligament length) during jetting in the air just after discharging become long, and image defects may occur due to the increased number of satellite droplets.

The ink heating unit is not particularly limited as long as the ink heating unit is capable of heating the ink to the desired temperature, and may be appropriately selected depending on the intended purpose. Examples of the ink heating unit include, but are not limited to, a unit configured to increase the temperature of a head and a unit configured to increase the temperature of the surrounding environment. The heating temperature of the ink means a set temperature of the ink heating unit. Moreover, the “unit configured to increase the temperature of a head” means a unit configured to heat by a heater disposed inside the head, and the “unit configured to increase the temperature of the surrounding environment” means a unit configured to increase the atmospheric temperature surrounding the printer by air conditioning.

The heating temperature of the ink is preferably 30° C. or higher but 40° C. or lower and more preferably 30° C. or higher but 35° C. or lower. When the heating temperature is 30° C. or higher but 40° C. or lower, the effect of preventing formation of satellite droplets to prevent image defects can be improved while improving discharging stability of the ink.

Moreover, the below-described ink discharging unit preferably includes the ink heating unit. Since the ink discharging unit includes the ink heating unit, the viscosity of the ink can be sufficiently reduced just before discharging the ink.

### <Ink Discharging Unit and Ink Discharging Step>

The ink discharging unit is a unit configured to discharge the heated ink.

The ink discharging step is a step of discharging the heated ink.

The ink discharging step is suitably performed by the ink discharging unit.

As the ink discharging unit, any ink discharging unit known in the art can be used. Examples thereof include, but are not limited to, an ink discharging unit of an inkjet system.

Since the printing device includes the ink heating unit and the ink discharging unit, the viscosity of the ink is reduced at the time the ink is discharged, to secure discharging stability of the ink as well as preventing formation of image defects, even when the viscosity of the ink at 25° C. is high.

### <Ink Storing Unit>

The ink storing unit is a unit configured to store the ink.

Examples of the ink storing unit include, but are not limited to, ink cartridges for inkjet printers known in the art.

### <Other Units and Other Steps>

The above other units are not particularly limited and may be appropriately selected depending on the intended purpose. Examples thereof include, but are not limited to, a pre-processing unit, a post-processing unit, and a heat drying unit.

The above other steps are not particularly limited and may be appropriately selected depending on the intended purpose. Examples thereof include, but are not limited to, a pre-processing step, a post-processing step, and a heat drying step.

### <<Pre-Processing Unit and Pre-Processing Step>>

The pre-processing unit is a unit configured to apply a pre-processing fluid to a print medium before applying the ink.

The pre-processing step is a step of applying a pre-processing fluid to a print medium before applying the ink.

The pre-processing step can be suitably performed by the pre-processing unit.

The pre-processing unit is not particularly limited and may be appropriately selected depending on the intended purpose. Examples thereof include, but are not limited to: a unit configured to store the pre-processing fluid in an ink storing unit in a similar manner to a general ink and apply the pre-processing fluid to a print medium according to an inkjet system; and a unit using blade coating, roll coating, or spray coating.

### —Pre-Processing Fluid—

The pre-processing fluid contains a flocculant, an organic solvent, water, and optional materials such as a surfactant, a defoaming agent, a pH regulator, preservatives and fungicides and a corrosion inhibitor.

The organic solvent, the surfactant, the defoaming agent, the pH regulator, the preservatives and fungicides, and the corrosion inhibitor can be the same material as those for use in the ink. Also, other materials for use in known processing fluid can be used.

The type of the flocculant is not particularly limited. For example, water-soluble cationic polymers, acids, and multi-valent metal salts are suitable.

### <<Post-Processing Unit and Post-Processing Step>>

The post-processing unit is a unit configured to apply a post-processing fluid to a print medium after applying the ink.

The post-processing step is a step of applying a post-processing fluid to a print medium after applying the ink.

The post-processing step can be suitably performed by the post-processing unit.

The post-processing unit is not particularly limited and may be appropriately selected depending on the intended purpose. Examples thereof include, but are not limited to: a unit configured to store the post-processing fluid in an ink storing unit in a similar manner to a general ink and apply the post-processing fluid to a print medium according to an inkjet system; and a unit using blade coating, roll coating, or spray coating.

### —Post-Processing Fluid—

The post-processing fluid has no particular limit. It is preferable that the post-processing fluid can form a transparent layer. Materials such as organic solvents, water, resins, surfactants, defoaming agents, pH regulators, preservatives and fungicides, corrosion inhibitors, etc. are suitably selected based on a necessity basis and mixed to obtain the post-processing fluid. The post-processing fluid can be applied to the entire printing area on a print medium or only the printed area.

### [Print Medium]

The print medium used for printing is not particularly limited. Examples thereof include, but are not limited to, plain paper, gloss paper, special paper, cloth, films, OHP sheets, printing paper for general purposes, and continuous paper. The continuous paper is a print medium continued in the transporting direction at the time of image formation. Examples of the continuous paper include, but are not limited to, a paper roll where paper is wound to form a roll, and continuous paper folded at predetermined intervals.

### [Printed Matter]

The ink printed matter of the present disclosure includes a print medium, and an image formed on the print medium with the ink of the present disclosure.

An inkjet printing device and an inkjet printing method are used to print the image on the print medium to obtain the printed matter.

The printing device of the present disclosure will be described below with reference to drawings. The drawing is a schematic view illustrating one example of the printing device of the present disclosure.

The printing device 1 includes a feeding unit 10, a pre-processing unit 50, a printing unit 20, a drying unit 30, and an outputting unit 40. In the printing device 1, a processing fluid is applied by the pre-processing unit 50 to a sheet material P fed from the feeding unit 10, followed by applying a liquid by the printing unit 20 to perform the predetermined printing. Then, the liquid deposited on the sheet material P is dried by the drying unit 30, followed by ejecting the sheet material P to the outputting unit 40.

The feeding unit 10 includes a feeding tray 11 where a plurality of the sheet materials P are loaded, a feeding device 12 configured to separate and feed the sheet material P one by one from the feeding tray 11, and a pair of registration rollers 13 configured to send the sheet material P to the printing unit 20.

As the feeding device 12, various feeding devices, such as a device using driving and/or driven rollers, and a device using air suction, can be used. After the edge of the sheet material P sent from the feeding tray 11 by the feeding device 12 reaches the pair of the registration rollers 13, the pair of the registration rollers 13 are driven at the predetermined timing to send the sheet material P to the printing unit 20.

The pre-processing unit 50 includes a processing fluid storage container 51 configured to store a processing fluid that reacts with the liquid to prevent bleeding, and a pre-coating processing rotating member serving as a processing fluid coating unit configured to apply the processing fluid to the sheet material P. The pre-coating processing rotating member includes a drawing roller configured to draw the processing fluid, a coating roller 52 configured to receive the processing fluid deposited on the drawing roller and apply the processing fluid to the surface of the fed sheet material, and a roller 53 disposed to be pressed against the coating roller to nip the sheet material between the roller 53 and the coating roller.

After applying the processing fluid on the bottom surface of the sheet material P by the coating roller 52, the sheet material P is flipped upside down, and then the sheet material P is transported to the pair of the registration rollers 13 constituting the feeding unit 10.

The printing unit 20 includes a sheet conveying device 21 configured to convey the sheet material P. The sheet conveying device 21 includes a belt configured to carry and convey the sheet material P, and a suction device configured to generate suction force on a surface of the belt.

Moreover, the printing unit 20 includes a liquid discharging unit 22 configured to discharge the liquid towards a surface of the sheet material P carried and conveyed by the belt of the sheet conveying device 21 to deposit the liquid on the surface of the sheet material P.

The liquid discharging unit 22 includes a discharging unit 23 (23A to 23F) that is a liquid applying unit. For example, the discharging unit 23A is configured to discharge a liquid of cyan (C), the discharging unit 23B is configured to discharge a liquid of magenta (M), the discharging unit 23C is configured to discharge a liquid of yellow (Y), and the discharging unit 23D is configured to discharge a liquid of black (K). Moreover, the discharging units 23E and 23F are used for discharging liquids of any of YMCK, or special liquids, such as white and gold (silver). Moreover, the liquid discharging unit 22 may further include a discharging unit configured to discharge a processing fluid, such as a surface coating liquid.

For example, the discharging unit 23 is a full-line head including a plurality of liquid discharging heads each having a nozzle array where a plurality of nozzles are aligned (hereinafter each of the liquid discharging heads may be referred to simply as a “head”).

The discharging operation of each discharging unit 23 of the liquid discharging unit 22 is controlled by a driving signal corresponding to printing information. When the sheet material P carried on the drum passes through the counter region relative to the liquid discharging unit 22, the liquid of the corresponding color is discharged from the discharging unit 23 to print an image corresponding the printing information.

The sheet material P on which the liquid is applied by the liquid discharging unit 22 is sent to a suction conveying system unit 31 of the drying unit 30.

The drying unit 30 includes the suction conveying system unit 31, which is a conveying unit configured to convey the sheet material P in the state where the sheet material P is suctioned (suction conveying), and a drying system unit 32 configured to dry the liquid on the sheet material P conveyed by the suction conveying system unit 31.

The sheet material P to which the liquid is applied by the printing unit 20 is dried by the drying system unit 32, while being conveyed by the suction conveying system unit 31, and the sheet material P is then sent to the outputting unit 40.

The outputting unit 40 includes an output tray 41 on which a plurality of sheet materials P are stacked. The sheet materials P sent from the drying unit 30 are sequentially stacked and retained on the output tray 41.

Although the pre-processing unit 50 is described as a unit configured to apply the processing fluid on one surface of the sheet material P, an embodiment thereof is not limited to such an embodiment. For example, another processing fluid storage container configured to apply the processing fluid onto a back surface of the sheet material P may be disposed at a position downstream of the processing fluid storage container 51 in the conveying direction. Alternatively, the sheet material P passed through the processing fluid storage container 51 may be flipped upside down, and the sheet material P may be passed through the processing fluid storage container 51 again to apply the processing fluid on the back surface of the sheet material P

### (Method for Producing Printed Matter and Device for Producing Printed Matter)

The method for producing printed matter of the present disclosure includes an ink heating step and an ink discharging step, and may further include other steps according to the necessity. The ink heating step is a step of heating an ink. The ink includes water, a metal pigment, and a resin. A mass ratio of the resin to the metal pigment is 0.1 or greater but 2 or less. A proportion of the water in the ink is 1% by mass or greater but 30% by mass or less. The ink discharging step is a step of discharging the ink heated.

The device for producing printed matter of the present disclosure includes an ink, an ink heating unit, and an ink discharging unit, and may further include other units according to the necessity. The ink heating unit is a unit configured to heat the ink. The ink includes water, a metal pigment and a resin. A mass ratio of the resin to the metal pigment is 0.1 or greater but 2 or less. A proportion of the water in the ink is 1% by mass or greater but 30% by mass or less. The ink discharging unit is a unit configured to discharge the heated ink.

The method for producing printed matter of the present disclosure is more suitably performed by the device for producing printed matter of the present disclosure.

The device and method for producing printed matter of the present disclosure are similar to the printing device and method of the present disclosure.

In other words, the method for producing printed matter of the present disclosure includes printing an image on a print medium using the printing device of the present disclosure.

### EXAMPLES

The present disclosure will be described below by way of Examples. The present disclosure should not be construed as being limited to these Examples.

### [Preparation of Metal Pigment Dispersion Liquid]

### <Preparation of Silver Particle Aqueous Dispersion Liquid>

The following materials were added to 100 parts by mass of ion-exchanged water, and the resultant mixture was vigorously stirred at 200 rpm, to obtain a suspension liquid. Silver nitrate: 66.8 parts by mass

Polymer dispersant including a carboxyl group (“DISPERBYK 190” obtained from BYK, solvent: water, nonvolatile component: 40%, acid value: 10 mgKOH/g, amine value: 0 mgKOH/g): 7.2 parts by mass
Cholic acid (obtained from FUJIFILM Wako Pure Chemical Corporation): 1.8 parts by mass

To the suspension liquid, 100 parts by mass of dimethylaminoethanol (obtained from FUJIFILM Wako Pure Chemical Corporation) was gradually added in a manner that the temperature of the water did not exceed 50° C., and the resultant was heated and stirred for 3 hours in a water bath having a water temperature of 50° C.

The obtained reaction liquid was filtered through a glass filter (GC-90, obtained from ADVANTEC, pore size: 0.8 μm) to obtain a silver particle aqueous dispersion liquid (silver (solid content): 15% by mass, polymer dispersant: 0.7% by mass, dimethylaminoethanol: 46.2% by mass).

### <Preparation of Aluminium Flakes-Diethylene Glycol Diethyl Ether Dispersion Liquid>

A stainless steel container was charged with the following materials, and the resultant mixture was sufficiently mixed by means of a high-speed disper.

Diethylene glycol diethyl ether (obtained from NIPPON NYUKAZAI CO., LTD.): 97 parts by mass
Cellulose acetate butyrate (butyration ratio: 35% through 39%, obtained from KANTO CHEMICAL CO., INC.): 3.0 parts by mass

The resultant dispersion liquid was uniformly applied onto a PET film by bar coating, and the applied dispersion liquid was dried at 70° C. for 10 minutes.

Next, vapor deposition of aluminium was performed by means of a vacuum vapor deposition device (VE-1010 vacuum vapor deposition device, obtained from Vacuum Device Co., Ltd.) to deposit 16 parts by mass of aluminium relative to 1 part by mass of the above cellulose acetate butyrate resin, to obtain a vapor deposition film (laminate).

The vapor deposition film was peeled and pulverized in diethylene glycol diethyl ether by means of VS-150 ultrasonic disperser (obtained from AS ONE Corporation) for 14 hours, to obtain a dispersion liquid.

The concentration of the obtained dispersion liquid was adjusted with diethylene glycol diethyl ether to obtain a resin-coated aluminium flakes-diethylene glycol diethyl ether dispersion liquid (aluminium: 20% by mass (solid content), cellulose acetate butyrate resin: 1.3% by mass, diethylene glycol diethyl ether: 78.7% by mass).

### <Preparation of Aluminium Flakes-2-Aminoethanol Dispersion Liquid>

A stainless steel container was charged with the following materials, and the resultant mixture was sufficiently mixed by means of a high-speed disper.

Diethylene glycol diethyl ether (obtained from NIPPON NYUKAZAI CO., LTD.): 97 parts by mass
Cellulose acetate butyrate (butyration ratio: 35% through 39%, obtained from KANTO CHEMICAL CO., INC.): 3.0 parts by mass

The resultant dispersion liquid was uniformly applied onto a PET film by bar coating, and the applied dispersion liquid was dried at 70° C. for 10 minutes.

Next, vapor deposition of aluminium was performed by means of a vacuum vapor deposition device (VE-1010 vacuum vapor deposition device, obtained from Vacuum Device Co., Ltd.) to deposit 16 parts by mass of aluminium relative to I part by mass of the above cellulose acetate butyrate resin, to obtain a vapor deposition film (laminate).

The vapor deposition film was peeled and pulverized in 2-aminoethanol (obtained from Tokyo Chemical Industry Co., Ltd.) by means of VS-150 ultrasonic disperser obtained from AS ONE Corporation) for 14 hours, to obtain a dispersion liquid.

The concentration of the obtained dispersion liquid was adjusted with 2-aminoethanol, to obtain a resin-coated aluminium flakes-2-aminoethanol dispersion liquid (aluminium (solid content): 20% by mass, cellulose acetate butyrate resin: 1.3% by mass, 2-aminoethanol: 78.7% by mass).

### [Preparation of Resin Dispersion Liquid]

### <Preparation of Polycarbonate-Based Urethane Resin Aqueous Dispersion Liquid>

A reaction vessel into which a stirrer, a reflux condenser tube, and a thermometer had been inserted was charged with the following materials under a nitrogen gas flow, and the resultant mixture was heated at 60° C. to dissolve DMPA.

Polycarbonate diol (reaction product between 1,6-hexanediol and dimethyl carbonate): 1,500 parts by mass
2,2-Dimethylol propionic acid (DMPA): 220 parts by mass
2-Aminoethanol: 1,347 parts by mass

Subsequently, the following materials were added, and the resultant mixture was heated to 90° C. to undergo a urethane reaction for 5 hours, to obtain an isocyanate-terminated urethane prepolymer.

4,4′-Dicyclohexylmethane diisocyanate: 1,445 parts by mass
Dibutyltin laurate (catalyst): 2.6 parts by mass

The obtained isocyanate-terminated urethane prepolymer was cooled to 80° C. To the resultant, 149 parts by mass of triethylamine was added and mixed. From the resultant, 4,340 parts by mass was removed, and the removed mixture was added to a mixed solution including 5,400 parts by mass of water and 15 parts by mass of triethylamine under vigorous stirring (200 rpm).

Subsequently, 1,500 parts by mass of ice was added, and 626 parts by mass of a 35% by mass 2-methyl-1,5-pentanediamine aqueous solution was added to perform a chain elongation reaction. Thereafter, the solvent was removed from the reaction mixture to adjust the solid content to 30% by mass, to obtain a polycarbonate-modified urethane resin emulsion (urethane resin solid content: 30% by mass, 2-aminoethanol: 6% by mass).

### <Preparation of Methacrylic Acid Resin-Diethylene Glycol Diethyl Ether Dispersion Liquid>

A mixed solution containing the following materials was added dropwise for 1.5 hours to 300 parts by mass of diethylene glycol diethyl ether, the temperature of which was being kept at 100° C.

Methyl methacrylate: 100 parts by mass
n-Butyl methacrylate: 50 parts by mass
ε-Caprolactone: 50 parts by mass
t-Butylperoxy-2-ethylhexanoate: 6.3 parts by mass

After completion of dropwise addition, the resultant mixture was allowed to react at 100° C. for 2 hours. The resultant was cooled and adjusted with diethylene glycol diethyl ether to have a solid content of 30% by mass and a diethylene glycol diethyl ether concentration of 70%, to obtain a methacrylic acid resin-diethylene glycol diethyl ether dispersion liquid.

### <Preparation of Methacrylic Acid Resin-2-Aminoethanol Dispersion Liquid>

A mixed solution containing the following materials was added dropwise for 1.5 hours to 300 parts by mass of 2-aminoethanol, the temperature of which was being kept at 100° C.

Methyl methacrylate: 100 parts by mass
n-Butyl methacrylate: 50 parts by mass
ε-Caprolactone: 50 parts by mass
t-Butylperoxy-2-ethylhexanoate: 6.3 parts by mass

After completion of dropwise addition, the resultant mixture was allowed to react at 100° C. for 2 hours. The resultant was cooled and adjusted with 2-aminoethanol to have a solid content of 30% by mass and a 2-aminoethanol concentration of 70%, to obtain a methacrylic acid resin-2-aminoethanol dispersion liquid.

### Examples 1 to 18 and Comparative Examples 1 to 5

The materials presented in Tables 1 to 5 were mixed to obtain Inks 1 to 23.

The viscosity of each of the obtained inks were measured. The viscosity was measured by means of a rotatory viscometer (RE-80L, obtained from TOKI SANGYO CO., LTD.) at 25° C. or 35° C. by Standard cone rotor (1° 34′×R24) with a sample liquid amount of 1.2 mL, at a rotational speed of 50 rpm, for 3 minutes.

The prepared inks 1 to 23 were used to print images under the following conditions, and were evaluated on “abrasion resistance” and” and “image gloss” of the printed images, “discharging stability of the ink,” and “occurrence of image defects” by means of the printer having the following ink heating unit.

### [Printer Having Ink Heating Unit]

As a printer having an ink heating unit, a device was used that had been obtained by mounting a head with a built-in heater (MH5320, obtained from Ricoh Company Limited) to Expanded Applicator EV2500 (obtained from Ricoh Company Limited).

The printer was charged with an ink by pressure, and 30 mL of the ink was passed through a path to confirm that the ink was charged. An ink to be evaluated was reduced in pressure at a reduced pressure of from 5 Pa through 10 Pa to remove the gas inside the ink to be evaluated. Also, a ribbon heater was wound around a tube of a supply path through which the ink was to be supplied to the head, to heat the tube to 30° C.

An image was printed by setting the driving voltage of the head to adjust the discharge amount so that the ink deposition amount of the image (solid image) on the print medium would be 20 g/m².

### [Printed Image]

A silver image (solid image) of 150 mm×150 mm created by Microsoft Word2003 (obtained from Microsoft Corporation) was printed on a gloss polyvinyl chloride sheet (model number SV-G-1270G, obtained from Roland DG Corporation) as the print medium, to thereby obtain a printed image. The printed image was evaluated on the following items.

### <Abrasion Resistance>

After drying for 5 hours, the image was set in Gakushin-type Color Fastness Rubbing Tester AB-301 (product name, obtained from TESTER SANGYO CO., LTD.) and the image was rubbed 10 times with a friction block (load: 300 g) to which white cotton fabrics (according to JIS L 0803) was attached in a contact area. The degree of deterioration was visually observed, and the abrasion resistance was evaluated based on the following criteria.

### [Evaluation Criteria]

3: The number of scratches was less than 5, and the base was not revealed.
2: The number of scratches was 5 or more but less than 10, and the base was not revealed.
1: The number of scratches was 10 or more, and the area where the base (printing subject) was revealed was 50% or less of the area of the image (solid image).
0: The number of scratches was 10 or more, and the area where the base (printing subject) was revealed was 50% or greater of the area of the image (solid image).

### <Discharging Stability of Ink>

After drying for 3 hours, the image was visually observed, and the number of occurrences of nozzle discharge failure was counted and evaluated based on the following criteria. When the number of the nozzle discharge failures (clogged nozzles) is 20 or greater, unevenness or unprinted lines are formed on printed matter, which is not suitable for practical use. Note that, the number of nozzles in the printer used was 192.

### [Evaluation Criteria]

3: The number of nozzle discharge failures was 0 or more but 5 or less.
2: The number of nozzle discharge failures was more than 5 but 10 or less.
1: The number of nozzle discharge failures was more than 10 but 20 or less.
0: The number of nozzle discharge failures was more than 20.

### <Occurrence of Image Defect>

The presence of the ink deposition in the region other than the silver image (solid image) of 150 mm×150 mm on the obtained printed matter was evaluated based on the following evaluation criteria.

### [Evaluation Criteria]

2: There was not ink deposition in the region other than the silver image (solid image).
1: There was slight ink deposition in the region other than the silver image (solid image).
0: There was significant ink deposition in the region other than the silver image (solid image).

### <Image Gloss>

The obtained image was measured for image gloss (glossiness) by the following method and the image gloss was evaluated based on the following evaluation criteria.

### [Measurement Method]

The glossiness was measured using a micro-tri-gloss meter obtained from BYK-Gardner GmbH and was evaluated.

Specifically, evaluation was performed on 5 sites of the image that had been drawn at 600×400 dpi, and the average of the obtained values was defined as glossiness.

### [Evaluation Criteria]

Evaluation was performed based on the following criteria in terms of the value of glossiness at 60°.

3: Glossiness was less than 5.
2: Glossiness was 5 or greater but less than 10.
1: Glossiness was 10 or greater but less than 15.
0: Glossiness was 15 or greater.

### <Comprehensive Evaluation>

The total points of the evaluations of “abrasion resistance,” “discharging stability of ink,” “occurrence of image defect,” and “image gloss” were calculated. When any of the evaluation items was “0 points,” the comprehensive evaluation was determined as “0”

TABLE 1

| | | Ex. | | | | |
|---|---|---|---|---|---|---|
| | | 1 | 2 | 3 | 4 | 5 |
| Ink No. | | 1 | 2 | 3 | 4 | 5 |
| Metal | Silver particle-water dispersion liquid (solid content: | 33.0 | 33.0 | 33.0 | 33.0 | 20.0 |
| pigment | 15 mass %, water: 38.1 mass %) | | | | | |
| dispersion | Aluminium flakes-diethylene glycol diethyl ether | | | | | |
| liquid | dispersion liquid | | | | | |
| | Aluminium flakes-2-aminoethanol dispersion liquid | | | | | |
| | (solid content: 20 mass %) | | | | | |
| Resin | Polycarbonate-based urethane resin-water dispersion | 1.3 | 1.3 | 6.7 | 6.7 | 10.0 |
| dispersion | liquid (solid content: 30 mass %, water: 64 mass %) | | | | | |
| liquid | Methacrylic resin-diethylene glycol diethyl ether | | | | | |
| | dispersion liquid | | | | | |
| | Methacrylic resin-2-aminoethanol dispersion liquid | | | | | |
| | (solid content: 30 mass %) | | | | | |
| Ion-exchanged water | | 14.1 | 14.1 | 12.8 | 12.8 | 13.4 |
| Water- | 2,4,7,9-tetramethyldecane-4,7-diol | 0.50 | 0.50 | 0.50 | 0.50 | 0.50 |
| soluble | 1,2-propanediol | 25.0 | 25.0 | 14.9 | 14.9 | 30.0 |
| organic | 3-ethyl-3-hydroxymethyloxetane | 25.0 | 25.0 | 25.0 | 25.0 | |
| solvent | γ-butyrolactone | | | 6.0 | 6.0 | |
| | diethylene glycol diethyl ether | | | | | 25.0 |
| | tetraethylene glycol monobutyl ether | | | | | |
| | 2-aminoethanol | | | | | |
| | diethylene glycol | | | | | |
| | glycerin | | | | | |
| Other | Preservative and fungicide PROXEL LV | 0.10 | 0.10 | 0.10 | 0.10 | 0.10 |
| additives | (from Avecia) | | | | | |
| | Silicone-based surfactant | 1.0 | 1.0 | 1.0 | 1.0 | 1.0 |
| | Surfactant: BY-K-323 | | | | | |
| Ink | Metal pigment solid content (mass parts) | 5.0 | 5.0 | 5.0 | 5.0 | 3.0 |
| component | Resin component (mass parts) | 0.62 | 0.62 | 2.2 | 2.2 | 3.1 |
| ratio | Resin component (mass parts)/metal pigment (mass | 0.13 | 0.13 | 0.45 | 0.45 | 1.05 |
| | parts) | | | | | |
| | Amount of water relative to total amount of ink | 27.5 | 27.5 | 29.7 | 29.7 | 27.4 |
| | (mass %) | | | | | |
| Viscosity at discharge temperature (mPa · s) | | 5.0 | 4.5 | 6.0 | 4.8 | 7.0 |
| Viscosity at 25° C. (mPa · s) | | 15.3 | 15.3 | 15.7 | 15.7 | 16.0 |
| Presence of ink heating unit | | present | present | present | present | present |
| Discharge temperature | | 35.0 | 42.0 | 35.0 | 42.0 | 35.0 |
| | abrasion resistance | 1 | 1 | 2 | 2 | 2 |
| Evaluation | discharging stability | 1 | 1 | 1 | 1 | 1 |
| results | image defects | 2 | 1 | 2 | 1 | 2 |
| | image gloss | 2 | 2 | 2 | 2 | 1 |
| | comprehensive evaluation | 6 | 5 | 7 | 6 | 6 |

TABLE 2

| | | Ex. | | | | |
|---|---|---|---|---|---|---|
| | | 6 | 7 | 8 | 9 | 10 |
| Ink No. | | 6 | 7 | 8 | 9 | 10 |
| Metal | Silver particle-water dispersion liquid (solid content: | 33.0 | 33.0 | 33.0 | 33.0 | 20.0 |
| pigment | 15 mass %, water: 38.1 mass %) | | | | | |
| dispersion | Aluminium flakes-diethylene glycol diethyl ether | | | | | |
| liquid | dispersion liquid | | | | | |
| | Aluminium flakes-2-aminoethanol dispersion liquid | | | | | |
| | (solid content: 20 mass %) | | | | | |
| Resin | Polycarbonate-based urethane resin-water dispersion | 12.0 | 15.0 | 22.0 | 30.0 | 10.0 |
| dispersion | liquid (solid content: 30 mass %, water: 64 mass %) | | | | | |
| liquid | Methacrylic resin-diethylene glycol diethyl ether | | | | | |
| | dispersion liquid | | | | | |
| | Methacrylic resin-2-aminoethanol dispersion liquid | | | | | |
| | (solid content: 30 mass %) | | | | | |
| Ion-exchanged water | | 5.0 | 2.5 | 2.4 | | 3.0 |
| Water- | 2,4,7,9-tetramethyldecane-4,7-diol | 0.50 | 0.50 | 0.50 | 0.50 | 0.50 |
| soluble | 1,2-propanediol | 14.9 | 14.9 | 16.0 | 25.0 | 30.0 |
| organic | 3-ethyl-3-hydroxymethyloxetane | 25.0 | 25.0 | 20.0 | 10.5 | |
| solvent | γ-butyrolactone | | | | | |
| | diethylene glycol diethyl ether | | | | | 25.0 |
| | tetraethylene glycol monobutyl ether | 8.5 | | | | |
| | 2-aminoethanol | | 8.0 | | | |
| | diethylene glycol | | | 5.0 | | |
| | glycerin | | | | 10.0 | |
| Other | Preservative and fungicide PROXEL LV | 0.10 | 0.10 | 0.10 | 0.10 | 0.10 |
| additives | (from Avecia) | | | | | |
| | Silicone-based surfactant | 1.0 | 1.0 | 1.0 | 1.0 | 1.0 |
| | Surfactant: BY-K-323 | | | | | |
| Ink | Metal pigment solid content (mass parts) | 1.0 | 1.0 | 5.0 | 5.0 | 3.0 |
| component | Resin component (mass parts) | 3.8 | 4.7 | 6.8 | 9.2 | 3.1 |
| ratio | Resin component (mass parts)/metal pigment (mass | 0.77 | 0.96 | 1.38 | 1.86 | 1.05 |
| | parts) | | | | | |
| | Amount of water relative to total amount of ink | 25.3 | 24.7 | 29.1 | 28.9 | 19.0 |
| | (mass %) | | | | | |
| Viscosity at discharge temperature (mPa · s) | | 7.1 | 7.5 | 8.0 | 8.3 | 7.0 |
| Viscosity at 25° C. (mPa · s) | | 16.5 | 16.6 | 16.9 | 17.2 | 16.0 |
| Presence of ink heating unit | | present | present | present | present | present |
| Discharge temperature | | 35.0 | 35.0 | 35.0 | 35.0 | 35.0 |
| Evaluation | abrasion resistance | 2 | 2 | 3 | 3 | 2 |
| results | discharging stability | 1 | 1 | 1 | 1 | 2 |
| | image defects | 2 | 2 | 2 | 1 | 2 |
| | image gloss | 2 | 2 | 2 | 2 | 1 |
| | comprehensive evaluation | 7 | 7 | 8 | 7 | 7 |

TABLE 3

| | | Ex. | | | | |
|---|---|---|---|---|---|---|
| | | 11 | 12 | 13 | 14 | 15 |
| Ink No. | | 11 | 12 | 13 | 14 | 15 |
| Metal | Silver particle-water dispersion liquid (solid content: | | | | | |
| pigment | 15 mass %, water: 38.1 mass %) | | | | | |
| dispersion | Aluminium flakes-diethylene glycol diethyl ether | 25.0 | 25.0 | 25.0 | 25.0 | 25.0 |
| liquid | dispersion liquid | | | | | |
| | Aluminium flakes-2-aminoethanol dispersion liquid | | | | | |
| | (solid content: 20 mass %) | | | | | |
| Resin | Polycarbonate-based urethane resin-water dispersion | | | | | |
| dispersion | liquid (solid content: 30 mass %, water: 64 mass %) | | | | | |
| liquid | Methacrylic resin-diethylene glycol diethyl ether | 1.0 | 1.0 | 6.0 | 12.0 | 12.0 |
| | dispersion liquid | | | | | |
| | Methacrylic resin-2-aminoethanol dispersion liquid | | | | | |
| | (solid content: 30 mass %) | | | | | |
| Ion-exchanged water | | 5.0 | 5.0 | 5.0 | 5.0 | 5.0 |
| Water- | 2,4,7,9-tetramethyldecane-4,7-diol | | | | | |
| soluble | 1,2-propanediol | | | | | |
| organic | 3-ethyl-3-hydroxymethyloxetane | | | | | |
| solvent | γ-butyrolactone | 6.0 | 6.0 | 6.0 | 6.0 | 6.0 |
| | diethylene glycol diethyl ether | 54.3 | 54.3 | 49.3 | 43.3 | 43.3 |
| | tetraethylene glycol monobutyl ether | 8.5 | 8.5 | 8.5 | 8.5 | 8.5 |
| | 2-aminoethanol | | | | | |
| | diethylene glycol | | | | | |
| | glycerin | | | | | |
| Other | Preservative and fungicide PROXEL LV | | | | | |
| additives | (from Avecia) | | | | | |
| | Silicone-based surfactant | | | | | |
| | Surfactant: BY-K-323 | 0.20 | 0.20 | 0.20 | 0.20 | 0.20 |
| Ink | Metal pigment solid content (mass parts) | 5.0 | 5.0 | 5.0 | 5.0 | 5.0 |
| component | Resin component (mass parts) | 0.63 | 0.63 | 2.1 | 3.9 | 3.9 |
| ratio | Resin component (mass parts)/metal pigment (mass | 0.13 | 0.13 | 0.43 | 0.79 | 0.79 |
| | parts) | | | | | |
| | Amount of water relative to total amount of ink | 5.0 | 5.0 | 5.0 | 5.0 | 5.0 |
| | (mass %) | | | | | |
| Viscosity at discharge temperature (mPa · s) | | 5.3 | 4.8 | 5.7 | 7.1 | 6.7 |
| Viscosity at 25° C. (MPa · s) | | 15.4 | 15.4 | 15.5 | 16.3 | 16.3 |
| Presence of ink heating unit | | present | present | present | present | present |
| Discharge temperature | | 35.0 | 43.0 | 35.0 | 35.0 | 41.0 |
| Evaluation | abrasion resistance | 1 | 1 | 2 | 2 | 2 |
| results | discharging stability | 3 | 3 | 3 | 3 | 3 |
| | image defects | 2 | 1 | 2 | 2 | 1 |
| | image gloss | 3 | 3 | 3 | 3 | 3 |
| | comprehensive evaluation | 9 | 8 | 10 | 10 | 9 |

TABLE 4

| | | Ex. | | |
|---|---|---|---|---|
| | | 16 | 17 | 18 |
| Ink No. | | 16 | 17 | 18 |
| Metal | Silver particle-water dispersion liquid (solid content: | 55.0 | 65 0 | 55.0 |
| pigment | 15 mass %, water: 38.1 mass %) | | | |
| dispersion | Aluminium flakes-diethylene glycol diethyl ether | | | |
| liquid | dispersion liquid | | | |
| | Aluminium flakes-2-aminoethartol dispersion liquid | | | |
| | (solid content: 20 mass %) | | | |
| Resin | Polycarbonate-based urethane resin-water dispersion | 20.0 | 20.0 | 5.0 |
| dispersion | liquid (solid content: 30 mass %, water: 64 mass %) | | | |
| liquid | Methacrylic resin-diethylene glycol diethyl ether | | | |
| | dispersion liquid | | | |
| | Methacrylic resin-2-aminoethanol dispersion liquid | | | |
| | (solid content: 30 mass %) | | | |
| Ion-exchanged water | | 5.0 | 1.0 | 5.0 |
| Water- | 2,4,7,9-tetramethyldecane-4,7-diol | | | |
| soluble | 1,2-propanediol | | | |
| organic | 3-ethyl-3-hydroxymethyloxetane | | | |
| solvent | γ-butyrolactone | 6.0 | 6,0 | 6.0 |
| | diethylene glycol diethyl ether | 5.3 | 0.8 | 20.3 |
| | tetraethylene glycol monobutyl ether | 8.5 | 7.0 | 8.5 |
| | 2-aminoethanol | | | |
| | diethylene glycol | | | |
| | glycerin | | | |
| Other | Preservative and fungicide PROXEL LV | | | |
| additives | (from Avecia) | | | |
| | Silicone-based surfactant | | | |
| | Surfactant: BYK-323 | 0.20 | 0.20 | 0.20 |
| ink | Metal pigment solid content (mass parts) | 11.0 | 13.0 | 11.0 |
| component | Resin component (mass parts) | 6.7 | 6.8 | 2.2 |
| ratio | Resin component (mass parts)/ | 0.61 | 0.53 | 0.20 |
| | metal pigment(mass parts) | | | |
| | Amount of water relative to total | 5.0 | 1.0 | 5.0 |
| | amount of ink (mass %) | | | |
| Viscosity at discharge temperature (mPa · s) | | 13.0 | 9.5 | 11.0 |
| Viscosity at 25° C. (mPa · s) | | 23.0 | 18.0 | 21.0 |
| Presence of ink heating unit | | present | present | present |
| Discharge temperature | | 35.0 | 35.0 | 35.0 |
| Evaluation | abrasion resistance | 3 | 3 | 2 |
| results | discharging stability | 3 | 3 | 1 |
| | image defects | 1 | 1 | 2 |
| | image gloss | 3 | 3 | 3 |
| | comprehensive evaluation | 10 | 10 | 8 |

TABLE 5

| | | Comp. Ex. | | | | |
|---|---|---|---|---|---|---|
| | | 1 | 2 | 3 | 4 | 5 |
| Ink No. | | 19 | 20 | 21 | 22 | 23 |
| Metal | Silver particle-water dispersion liquid (solid content: | 33.0 | 20.0 | 33.0 | | |
| pigment | 15 mass %, water: 38.1 mass %) | | | | | |
| dispersion | Aluminium flakes-diethylene glycol diethyl ether | | | | 25.0 | 25.0 |
| liquid | dispersion liquid | | | | | |
| | Aluminium flakes-2-aminoethanol dispersion liquid | | | | | |
| | (solid content: 20 mass %) | | | | | |
| Resin | Polycarbonate-based urethane resin-water dispersion | 0.300 | 35.0 | 1.30 | | |
| dispersion | liquid (solid content: 30 mass %, water: 64 mass %) | | | | | |
| liquid | Methacrylic resin-diethylene glycol diethyl ether | | | | 0.1 | 40.0 |
| | dispersion liquid | | | | | |
| | Methacrylic resin-2-aminoethanol dispersion liquid | | | | | |
| | (solid content: 30 mass %) | | | | | |
| Ion-exchanged water | | 35.2 | 13.5 | 24.2 | | |
| Water- | 2,4,7,9-tetramethyldecane-4,7-diol | 0.50 | 0.50 | 0.50 | | |
| soluble | 1,2-propanediol | 14.9 | 14.9 | 14.9 | | |
| organic | 3-ethyl-3-hydroxymethyloxetane | 15.0 | 15.0 | 15.0 | | |
| solvent | γ-butyrolactone | | | | 6.0 | 6.0 |
| | diethylene glycol diethyl ether | | | | 60.2 | 20.3 |
| | tetraethylene glycol monobutyl ether | | | | 8.5 | 8.5 |
| | 2-aminoethanol | | | | | |
| | diethylene glycol | | | | | |
| | glycerin | | | | | |
| Other | Preservative and fungicide PROXEL LV | 0.10 | 0.10 | 0.10 | | |
| additives | (from Avecia) | | | | | |
| | Silicone-based surfactant | 1.0 | 1.0 | 1.0 | | |
| | Surfactant: BY-K-323 | | | | 0.20 | 0.20 |
| Ink | Metal pigment solid content (mass parts) | 5.0 | 3.0 | 5.0 | 5.0 | 5.0 |
| component | Resin component (mass parts) | 0.32 | 10.6 | 0.62 | 0.36 | 12.3 |
| ratio | Resin component (mass parts)/metal pigment (mass | 0.06 | 3.55 | 0.13 | 0.07 | 2.47 |
| | parts) | | | | | |
| | Amount of water relative to total amount of ink | 48.0 | 43.5 | 37.6 | 0.0 | 0.0 |
| | (mass %) | | | | | |
| Viscosity at discharge temperature (mPa · s) | | 4.8 | 6.4 | 16.0 | 5.0 | 11.0 |
| Viscosity at 25° C. (mPa · s) | | 15.1 | 16.0 | 25.0 | 15.3 | 21.0 |
| Presence of ink heating unit | | present | present | absent | present | present |
| Discharge temperature | | 35.0 | 35.0 | 25.0 | 35.0 | 35.0 |
| Evaluation | abrasion resistance | 0 | 3 | 1 | 0 | 7 |
| results | discharging stability | 0 | 0 | 0 | 3 | 3 |
| | image defects | 2 | 0 | 0 | 2 | 0 |
| | image gloss | 3 | 2 | 3 | 3 | 3 |
| | comprehensive evaluation | 0 | 0 | 0 | 0 | 0 |

For example, aspects and embodiments of the present disclosure are as follows.

<1> A printing device including:

an ink, the ink including water, a metal pigment, and a resin, where a mass ratio of the resin to the metal pigment is 0.1 or greater but 2 or less, and a proportion of the water in the ink is 1% by mass or greater but 30% by mass or less:

an ink heating unit configured to heat the ink; and

an ink discharging unit configured to discharge the ink heated.

<2> The printing device according to <1>, wherein the metal pigment includes at least one member selected from the group consisting of silver and aluminium.

<3> The printing device according to <2>, wherein the aluminium includes aluminium flakes each including a resin coating on a surface of each of the aluminium flakes.

<4> The printing device according to any one of <1> to <3>, wherein the ink discharging unit includes the ink heating unit.

<5> The printing device according to any one of <1> to <4>, wherein the ink heating unit controls viscosity of the ink to be in a range of 5.0 mPa·s or greater but 15 mPa-s or less when the ink is discharged.

<6> The printing device according to any one of <1> to <5>, wherein the resin includes a methacrylic acid resin.

<7> The printing device according to any one of <1> to <6>, wherein the ink further includes an organic solvent.

<8> The printing device according to <7>, wherein the organic solvent includes an ether-based solvent.

<9> The printing device according to any one of <1> to <8>, wherein a proportion of the resin in the ink is 0.50% by mass or greater but 10% by mass or less.

<10> The printing device according to any one of <1> to <9>, wherein the ink discharging unit is of an inkjet system.

<11> The printing device according to any one of <1> to <10>, further including an ink storing unit storing the ink.

<12> A method for producing printed matter, the method including

printing an image on a print medium using the printing device according to any one of <1> to <11>.

<13> A method for producing printed matter, the method including:

heating an ink, the ink including water, a metal pigment, and a resin, where a mass ratio of the resin to the metal pigment is 0.1 or greater but 2 or less, and a proportion of the water in the ink is 1% by mass or greater but 30% by mass or less; and

discharging the ink heated.

<14> A device for producing printed matter, the device including:

an ink, the ink including water, a metal pigment, and a resin, where a mass ratio of the resin to the metal pigment is 0.1 or greater but 2 or less, and a proportion of the water in the ink is 1% by mass or greater but 30% by mass or less;

an ink heating unit configured to heat the ink; and

an ink discharging unit configured to discharge the ink heated.

The printing device according to any one of <1> to <11>, the method for producing printed mattered matter according to <12> or <13>, and the device for producing printed mattered matter according to <14> can solve the above-described various problems existing in the art, and can achieve the object of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A printing device comprising:
an ink, the ink including water, a metal pigment, and a resin, where a mass ratio of the resin to the metal pigment is 0.1 or greater but 2 or less, and a proportion of the water in the ink is 1% by mass or greater but 30% by mass or less:
an ink heating unit configured to heat the ink; and
an ink discharging unit configured to discharge the ink heated.

2. The printing device according to claim 1, wherein the metal pigment includes at least one member selected from the group consisting of silver and aluminium.

3. The printing device according to claim 2, wherein the aluminium includes aluminium flakes each including a resin coating on a surface of each of the aluminium flakes.

4. The printing device according to claim 1, wherein the ink discharging unit includes the ink heating unit.

5. The printing device according to claim 1, wherein the ink heating unit controls viscosity of the ink to be in a range of 5.0 mPa·s or greater but 15 mPa·s or less when the ink is discharged.

6. The printing device according to claim 1, wherein the resin includes a methacrylic acid resin.

7. The printing device according to claim 1, wherein the ink further includes an organic solvent.

8. The printing device according to claim 7, wherein the organic solvent includes an ether-based solvent.

9. The printing device according to claim 1, wherein a proportion of the resin relative in the ink is 0.50% by mass or greater but 10% by mass or less.

10. The printing device according to claim 1, wherein the ink discharging unit is of an inkjet system.

11. The printing device according to claim 1, further comprising
an ink storing unit storing the ink.

12. A method for producing printed matter, the method including
printing an image on a print medium using the printing device according to claim 1.

13. A method for producing printed matter, the method including:
heating an ink, the ink including water, a metal pigment, and a resin, where a mass ratio of the resin to the metal pigment is 0.1 or greater but 2 or less, and a proportion of the water in the ink is 1% by mass or greater but 30% by mass or less; and
discharging the ink heated.

14. A device for producing printed matter, the device including:
an ink, the ink including water, a metal pigment, and a resin, w % here a mass ratio of the resin to the metal pigment is 0.1 or greater but 2 or less, and a proportion of the water in the ink is 1% by mass or greater but 30% by mass or less:
an ink heating unit configured to heat the ink; and
an ink discharging unit configured to discharge the ink heated.
